(19) United States
(12) Patent Application Publication
(10) Pub. No.: US 2018/0286140 A1
(43) Pub. Date: Oct. 4, 2018

(54) INFORMATION PROCESSING APPARATUS AND INFORMATION PROCESSING METHOD

(71) Applicant: FUJITSU LIMITED, Kawasaki-shi (JP)

(72) Inventors: Takehiko Nishimura, Kawasaki (JP); Hiroki Nikai, Ota (JP); Hiroyuki Matsushita, Kawasaki (JP)

(73) Assignee: FUJITSU LIMITED, Kawasaki-shi (JP)

(21) Appl. No.: 15/925,244

(22) Filed: Mar. 19, 2018

(30) Foreign Application Priority Data
Mar. 29, 2017 (JP) 2017-064491

(51) Int. Cl. G07C 3/00; G07C 1/02; G07C 3/08; G06F 17/10

(52) U.S. Cl. CPC G07C 3/005; G06F 17/10; G07C 3/08; G07C 1/02

(57) ABSTRACT

An information processing method executed by an information processing apparatus configured to calculate a number of in-process products existing between a first process executed by a first device and a second process executed by a second device in a production line, the method includes acquiring, from the first device, an end log of the first process; adding a value to the number of in-process products according to the acquired end log; acquiring, from the second device, a start log of the second process; subtracting a value from the number of in-process products according to the acquired start log; and adjusting the number of in-process products to 0 when it is determined that no start log of the second process has occurred over a period longer than or equal to a threshold value in a state where the number of in-process products is greater than or equal to 1.

### CROSS-REFERENCE TO RELATED APPLICATION

This application is based upon and claims the benefit of priority of the prior Japanese Patent Application No. 2017-64491, filed on Mar. 29, 2017, the entire contents of which are incorporated herein by reference.

### FIELD

The embodiments discussed herein are related to an information processing apparatus and an information processing method.

### BACKGROUND

In producing products in a production line, it is known to calculate the amount of work-in-process inventory between processes.

To make the above calculation, for example, it has been proposed to use a work-in-process inventory calculation apparatus configured to store status information including information indicating an end time of the previous process and a start time of the following process for each of a plurality of products of interest. In this apparatus, a process lead time that inevitably occurs between the previous process and following process is determined from the status information, and a pipeline inventory is calculated from the determined process lead time. Furthermore, this apparatus is configured to determine the performing order in the previous process and the performing order in the following process for each of the plurality of products, and calculate an amount of work in process inventory for buffering a change in the performing order based on the determined performing order. The apparatus then determines a production quantity per unit time in the previous process and the following process, and calculates an amount of work in process inventory for buffering a change in the production quantity between the processes based on a change in the determined production quantity, and further calculates a proper amount of inventory between the processes. Descriptions of the related art may be found, for example, in Japanese Laid-open Patent Publication No. 2015-219552.

As for the intermediate buffer size indicating the maximum allowable work in process between processes in a production line, it is preferable to set the intermediate buffer size to a proper value such that even in a state in which a certain process stops, production in preceding and following processes is further continued for a certain period. For example, in a case where the intermediate buffer size is too large, an increase occurs in the cost for the work-in-process inventory. On the contrary, in a case where the intermediate buffer size is too small, when a certain process stops, the stopping of the process may impose a large influence on a preceding or following process. The setting of the intermediate buffer size and the flow of work-in-process are monitored and adjusted, for example, by detecting a time-series status in terms of the amount of work-in-process inventory, that is, the number of work in process between processes.

However, depending on products in process and/or devices performing respective processes, there is a possibility that it is difficult to assign identification information to each work in process, and thus it is difficult to accurately grasp the amount of work-in-process inventory between processes. There is a possibility that a work in process is taken out or added between processes. However, such a status is not detected from the status information according to the conventional technique. In view of the above, it is desirable to provide a technique to properly calculate the amount of work-in-process inventory between processes.

### SUMMARY

According to an aspect of the invention, an information processing method executed by a processor included in an information processing apparatus configured to calculate a number of in-process products existing between a first process executed by a first device and a second process executed following the first process by a second device in a production line, the information processing method includes acquiring, from the first device, an end log indicating an event of ending of the first process; adding a value to the number of in-process products according to the acquired end log; acquiring, from the second device, a start log indicating an event of starting of the second process; subtracting a value from the number of in-process products according to the acquired start log; and adjusting the number of in-process products to 0 when it is determined that no start log of the second process has occurred over a period longer than or equal to a threshold value in a state where the number of in-process products is greater than or equal to 1.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is a block diagram schematically illustrating a production line;

FIG. 2 is a functional block diagram illustrating a calculation apparatus according to one of first to third embodiments;

FIGS. 3A to 3D are diagrams for illustrating processes performed by an addition unit and a subtraction unit;

FIG. 4 is a diagram illustrating taking out of a work in process;

FIGS. 5A to 5D are diagrams for illustrating a process performed by an adjustment unit according to a first embodiment;

FIG. 6 is a diagram illustrating an example of an alert screen according to the first embodiment;

FIG. 7 is a diagram illustrating, in a simplified manner, an example of a work-in-process inventory screen according to the first embodiment;

FIG. 8 is a diagram illustrating an example of a work-in-process inventory screen;

FIG. 9 is a block diagram schematically illustrating a configuration of a computer functioning as a calculation apparatus according to one of first to third embodiments;

FIG. 10 is a flow chart illustrating an example of an initial process;

FIG. 11 is a flow chart illustrating an example of a calculation process (#1);

FIG. 12 is a flow chart illustrating an example of a display apparatus;

FIGS. 13A to 13D are diagrams for illustrating an effect according to the first embodiment;

FIG. 14 is a diagram illustrating adding of a work in process;

FIGS. 15A to 15D are diagrams for illustrating a process performed by an adjustment unit according to a second embodiment;

FIG. 16 is a diagram illustrating an example of an alert screen according to the second embodiment;

FIG. 17 is a diagram illustrating, in a simplified manner, an example of a work-in-process inventory screen according to the second embodiment;

FIG. 18 is a flow chart illustrating an example of a calculation process (#2);

FIGS. 19A to 19D are diagrams for illustrating an effect according to the second embodiment;

FIGS. 20A to 20C are diagrams for illustrating a process performed by an adjustment unit according to a third embodiment;

FIG. 21 is a diagram illustrating an example of an alert screen according to the third embodiment;

FIG. 22 is a diagram illustrating, in a simplified manner, an example of a work-in-process inventory screen according to the third embodiment;

FIG. 23 is a flow chart illustrating an example of a calculation process (#3);

FIGS. 24A to 24D are diagrams for illustrating an effect according to the third embodiment; and

FIG. 25 is a flow chart illustrating an example of a calculation process (#4).

### DESCRIPTION OF EMBODIMENTS

The techniques of the present disclosure are described in detail below with reference to embodiments in conjunction with drawings. In each embodiment described below, the process B is a process following the process A. Hereinafter, the process A will also be referred to as a “previous process”, and the process B will also be referred to as a “following process”. The process A (the previous process) is an example of a first process according to the technique of the present disclosure. The process B (the following process) is an example of a second process according to the technique of the present disclosure.

### First Embodiment

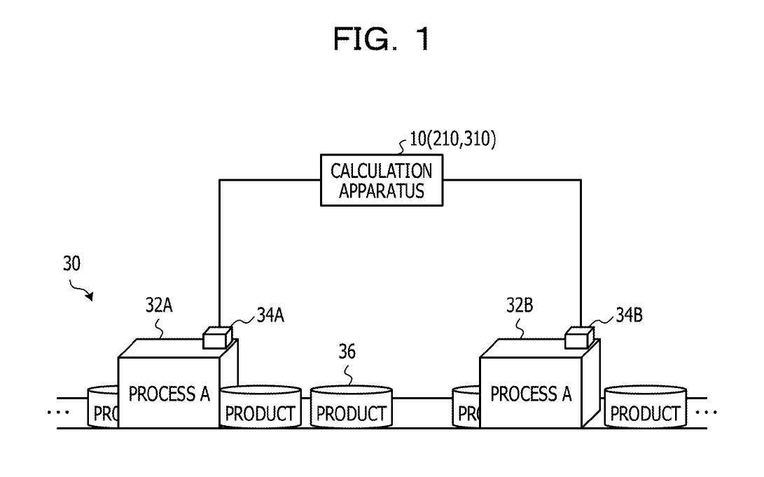

As illustrated in FIG. 1, a device 32A and a device 32B are disposed on a production line 30. The device 32A is for performing the process A on a product 36 and the device 32B is for performing the process B on the product 36 in the middle of the production of the product 36. In the present embodiment, the calculation of the amount of work-in-process inventory between processes is performed on such products 36 that are waiting for being subjected to the process B after having been subjected to the process A, that is, the product 36 in an intermediate state between the process A and the process B.

A log apparatus 34A is provided on the device 32A, and a log apparatus 34B is provided on the device 32B. Hereinafter, when the devices 32A and 32B are not distinguished between each other in the following description, they will be referred to generically as a “device 32” or “devices 32”. Similarly, when the log apparatuses 34A and 34B are not distinguished between each other, they will be referred to generically as a “log apparatus 34” or “log apparatuses 34”.

Each log apparatus 34 is an apparatus configured to record, in a log, an event that occurs as a corresponding device 32 operates together with a time of occurrence of the event. Examples of events include starting and ending of the device 32, and starting and ending of a process on each product 36. Hereinafter, a log associated with an event indicating starting of a process on a product 36 will be referred to as a “start log”, and a log associated with an event indicating ending of a process on a product 36 will be referred to as a “end log”. Each log apparatus 34 is connected, wirelessly or via a cable, to a calculation apparatus 10 according to the present embodiment.

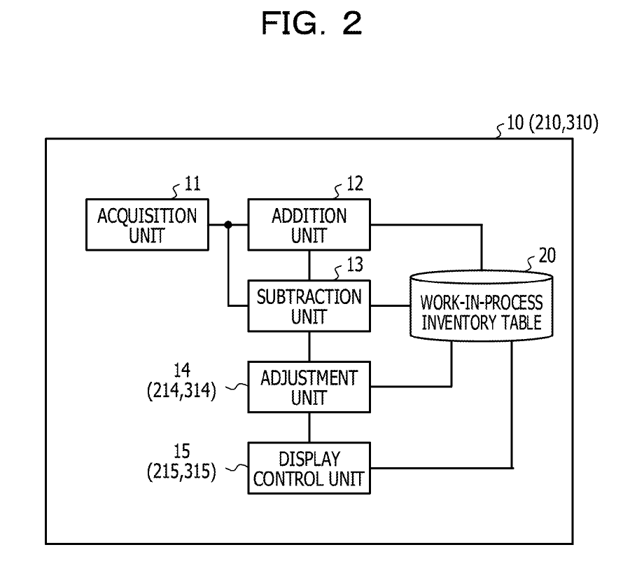

The calculation apparatus 10 includes, as illustrated in FIG. 2, functional blocks including an acquisition unit 11, an addition unit 12, a subtraction unit 13, an adjustment unit 14, and a display control unit 15. A work-in-process inventory table 20 is stored in a predetermined storage area of the calculation apparatus 10.

The work-in-process inventory table 20 is a table in which data is stored on a time series basis in terms of an end time of the previous process, a start time of the following process, and the amount of work-in-process inventory indicating the number of works in process between processes at the time.

The acquisition unit 11 acquires logs from the respective log apparatuses 34. Of the acquired logs, an end log acquired from the log apparatus 34 disposed on the device 32 that performs the previous process (that is, an end log acquired from the log apparatus 34A disposed on the device 32A that performs the process A) is transferred from the acquisition unit 11 to the addition unit 12. On the other hand, of the acquired logs, a start log acquired from the log apparatus 34 disposed on the device 32 that performs the following process (that is, a start log acquired from the log apparatus 34B disposed on the device 32B that performs the process B) is transferred from the acquisition unit 11 to the subtraction unit 13.

At a predetermined particular time, for example, immediately before the operation of the production line 30 is started, the acquisition unit 11 receives an input of data of the initial amount of work-in-process inventory indicating the number of works in process existing between processes, and the acquisition unit 11 transfers the data of the initial amount of work-in-process inventory to the addition unit 12.

When the addition unit 12 receives an end log from the acquisition unit 11, the addition unit 12 adds, to the work-in-process inventory table 20, data that is associated with an end time of the previous process indicated by the end log and that is for adding 1 to the amount of work-in-process inventory. In a case where the end log indicates ends of the previous process for a plurality of products 36, the addition unit 12 may increase the amount of work-in-process inventory by an amount corresponding to the number of products 36 indicated by the end log. When the addition unit 12 receives the data of the initial amount of work-in-process inventory from the acquisition unit 11, the addition unit 12 adds the data of the initial amount of work-in-process inventory to the work-in-process inventory table 20.

When the subtraction unit 13 receives a start log from the acquisition unit 11, the subtraction unit 13 generates data that includes information indicating a start time of the following process described in the start log and that is to cause 1 to be subtracted from the amount of work-in-process inventory, and the subtraction unit 13 adds the generated data to the work-in-process inventory table 20. In a case where the start log indicates starts of the following process for a plurality of products 36, the subtraction unit 13 may reduce the amount of work-in-process inventory by an amount corresponding to the number of products 36 indicated by the start log.

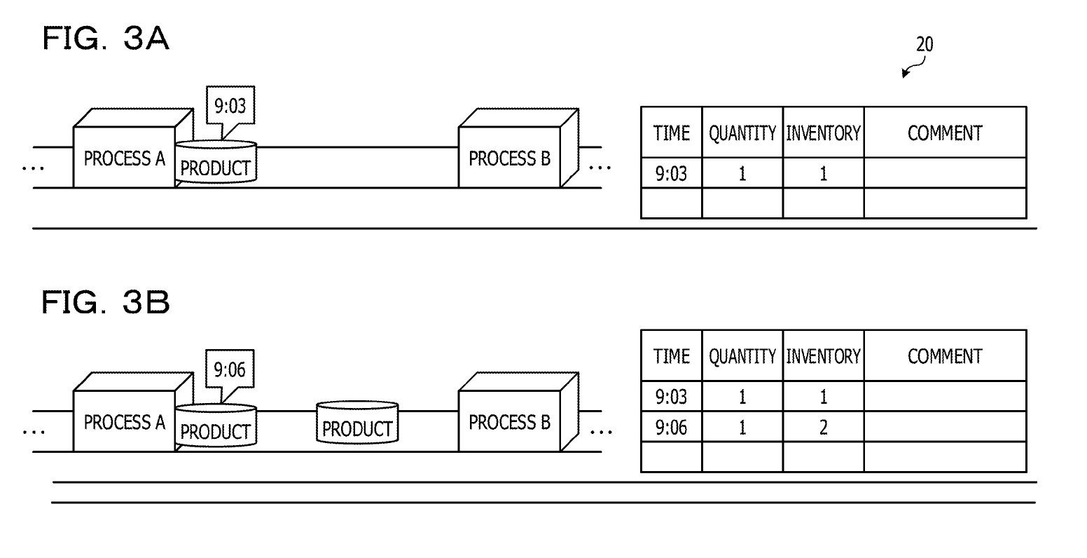

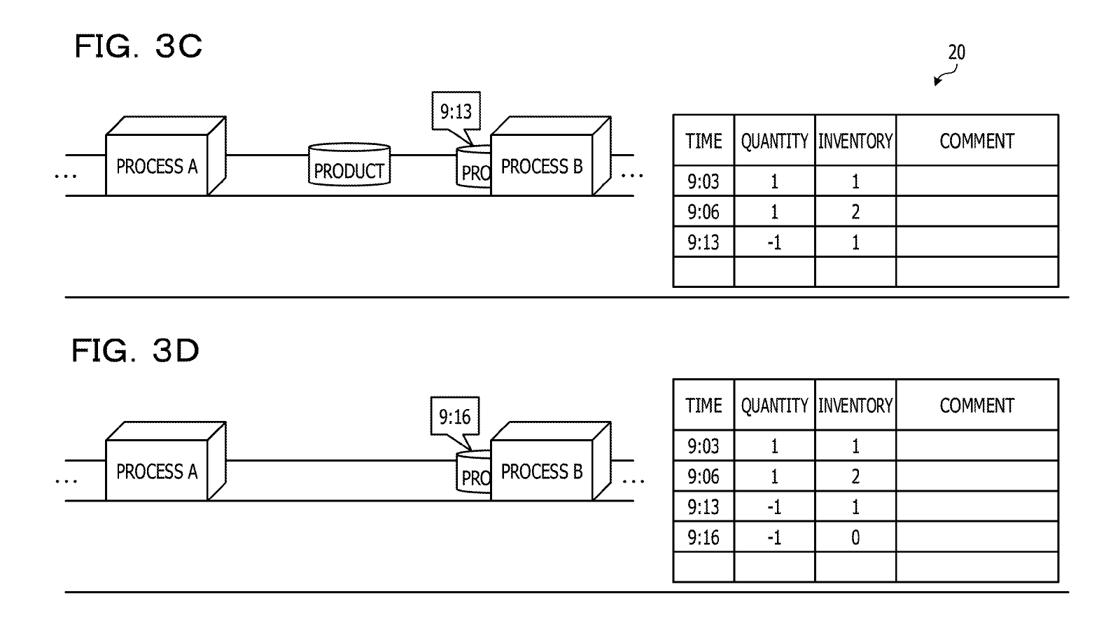

Referring to FIGS. 3A to 3D, an example of the work-in-process inventory table 20 and examples of processes performed by the addition unit 12 and the subtraction unit 13 are described below. In the example illustrated in FIGS. 3A to 3D, the work-in-process inventory table 20 includes a field of “time” indicating an event occurrence time, a field of “quantity” indicating a change in the amount of work-in-process inventory that occurred at the time indicated in the “time” field, a field of “inventory” indicating the amount of work-in-process inventory after the change, and a field of “comment”. The value described in the “inventory” field is equal to a value obtained as a result of adding or subtracting the value described in the “quantity” field of data previous to the data of interest to or from the value described in the “inventory” field of the data of interest.

In FIG. 3A, it is assumed by way of example that the previous process for a product 36 is ended at time 9:03. Thus, an end log indicating an end time 9:03 is sent to the addition unit 12. In response to receiving the end log, the addition unit 12 records data, for adding 1 to the amount of work-in-process inventory, in the work-in-process inventory table 20. More specifically, the data describing “9:03” as the “time” and “1” as the “quantity” is stored in the work-in-process inventory table 20. As a result, the value in the “inventory” field becomes equal to “1”. In the example illustrated in FIGS. 3A to 3D, it is assumed that the initial amount of work-in-process inventory is 0.

In FIG. 3B, it is assumed by way of example that the previous process for a next product 36 ends at 9:06. Thus, the addition unit 12 stores the data describing “9:06” as the “time” and “1” as the “quantity” in the work-in-process inventory table 20. As a result, the value in the “inventory” field becomes equal to “2”.

In FIG. 3C, it is assumed by way of example that the following process for the product 36 whose previous process was already ended is started at 9:13. Thus, a start log indicating a start time 9:13 is sent to the subtraction unit 13. In response to receiving the start log, the subtraction unit 13 records data, for reducing the amount of work-in-process inventory by 1 in the work-in-process inventory table 20. More specifically, the data describing “9:13” as the “time” and “−1” as the “quantity” is stored in the work-in-process inventory table 20. As a result, the value in the “inventory” field becomes equal to “1”.

In FIG. 3D, it is assumed by way of example that the following process for a following product 36 starts at 9:16. Thus, the subtraction unit 13 stores data describing “9:16” as the “time” and “−1” as the “quantity” in the work-in-process inventory table 20. As a result, the value in the “inventory” field becomes equal to “0”.

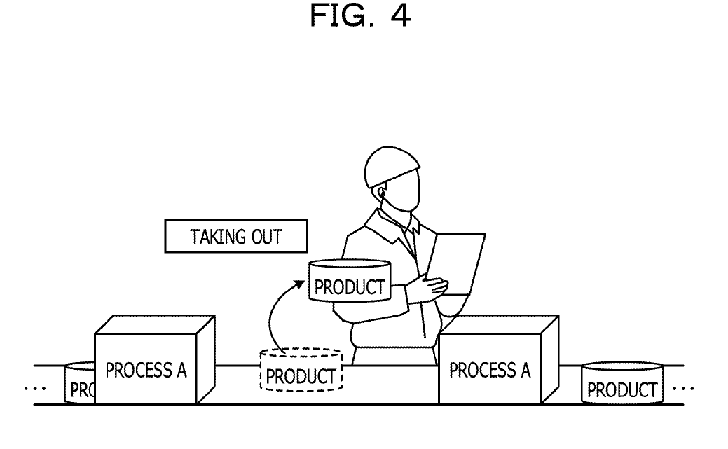

In the production line 30, there is a possibility that a worker takes out a product 36 (a work in process) between processes to check the work in process or remove a defective work as illustrated in FIG. 4. However, taking out of a work in process between processes is not recorded by a log apparatus 34 of any device 32. Therefore, when taking out occurs, the amount of work-in-process inventory between processes is not correctly grasped from data acquired only from end logs of the previous process and start logs of the following process, as illustrated in FIGS. 3A to 3D.

To handle the above situation, the present embodiment provides the adjustment unit 14 that operates such that when the amount of work-in-process inventory indicated in the “inventory” field in the work-in-process inventory table 20 is larger than or equal to 1, if a start log of the following process does not occur over a period longer than or equal to a threshold value, the adjustment unit 14 adjusts the amount of work-in-process inventory in the work-in-process inventory table 20 to 0.

More specifically, the adjustment unit 14 measures an elapsed time since data corresponding to a start log of the following process is stored in the work-in-process inventory table 20. Each time data corresponding to a start log of the following process is newly stored in the work-in-process inventory table 20, the adjustment unit 14 resets the elapsed time in the measurement. If the amount of work-in-process inventory indicated in the “inventory” field in the work-in-process inventory table 20 has remained at a value larger than or equal to 1 over a period larger than a predetermined value (for example, 10 minutes), the adjustment unit 14 generates a no-work-in-process event indicating that there is no work in process between processes A and B. When the no-work-in-process event occurs, the adjustment unit 14 generates correction data for reducing the amount of work-in-process inventory indicated in the “inventory” field in the work-in-process inventory table 20 and adds the generated correction data to the work-in-process inventory table 20. The adjustment unit 14 sets the value in the “time” field of the correction data to be equal to a time of occurrence of the no-work-in-process event, that is, to a time of expiration of a predetermined period since a previous occurrence of storing data in the work-in-process inventory table 20 in response to a start log of the following process.

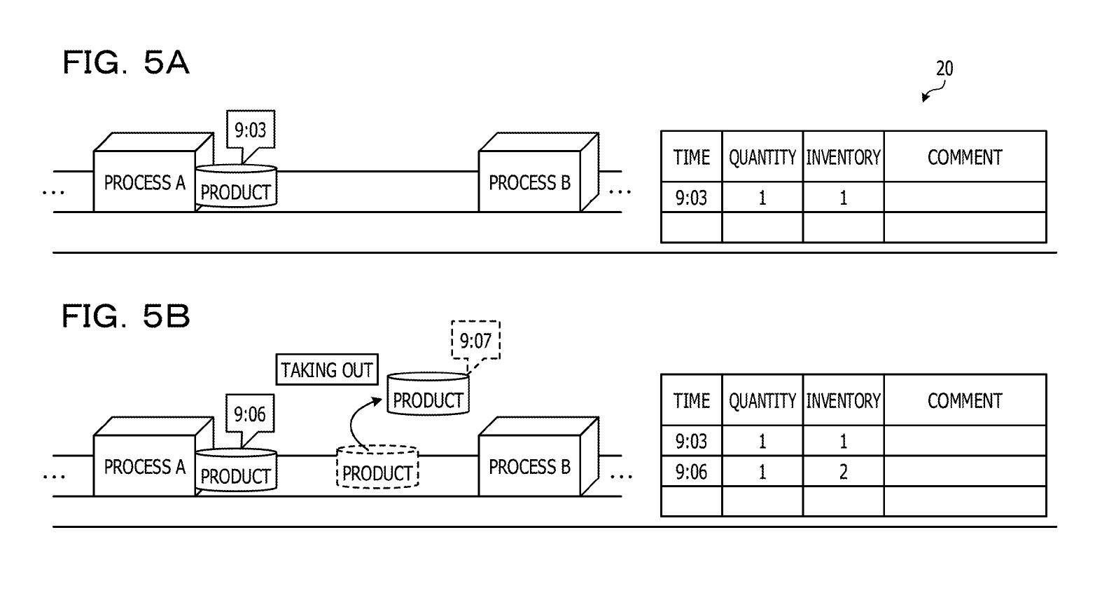

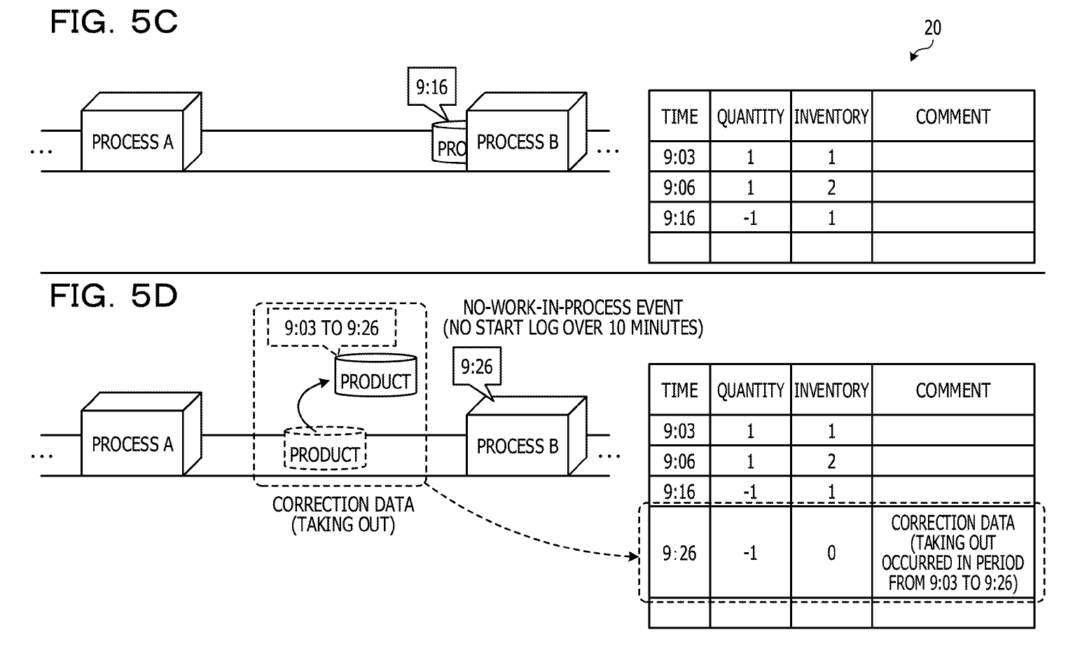

Referring to FIGS. 5A to 5D, an example of a process performed by the adjustment unit 14 is described below. As illustrated in FIGS. 5A and 5B in response to respective end logs of the previous process at 9:03 and at 9:06, the addition unit 12 adds data for adding 1 to the amount of work-in-process inventory as with the case in FIGS. 3A and 3B. As a result, the value in the “inventory” field in the work-in-process inventory table 20 becomes equal to “2”. In this state, let it be assumed by way of example as illustrated in FIG. 5B that one of two works in process is taken out at 9:07 between the processes A and B. However, this situation is not detected by the log apparatus 34, and thus no change occurs in the value indicated in “inventory” field in the work-in-process inventory table 20 although the actual amount of work-in-process inventory decreases by 1.

Let it be assumed by way of example that the following process for the other one of the works in process is started at 9:16 as illustrated in FIG. 5C. In response to this start log, the subtraction unit 13 adds data for reducing the amount of work-in-process inventory by 1. As a result, the value in the “inventory” field becomes equal to “1”. However, the actual amount of work-in-process inventory is 0 because of the reduction caused by the taking out, and thus the data stored in the work-in-process inventory table 20 in response to the start log of the following process is not correct. To handle the above situation, after waiting for a predetermined period (10 minutes in the present example), the adjustment unit 14 generates a no-work-in-process event at 9:26. Thereafter, the adjustment unit 14 generates correction data in which “9:26” indicating the time of occurrence of the no-work-in-process event is described in the “time” field, “−1” is described in the “quantity” field which will cause the value in the “inventory” field in the work-in-process inventory table 20 to be changed from the current value of 1 to 0, and the adjustment unit 14 adds the generated correction data to the work-in-process inventory table 20.

In the “comment” field in the correction data, the adjustment unit 14 describes information indicating that the data of interest is correction data and information indicating a time period in which there is a possibility that taking out of a work in process has occurred. The time period in which there is a possibility that taking out of a work in process has occurred is a period from the time at which the value in the “inventory” field in the work-in-process inventory table 20 becomes greater than or equal to 1 to the time at which the no-work-in-process event occurs. This description makes it possible to grasp the time period in which the work in process is likely to have been taken out. That is, the correction data added by the adjustment unit 14 is data describing the taking out of a work in process that occurs as represented in an area surround by a dotted line in FIG. 5D.

In response to the occurrence of the no-work-in-process event in the adjustment unit 14, the display control unit 15 displays an alert screen on a display apparatus disposed in the calculation apparatus 10 or a display apparatus connected to the calculation apparatus 10 wirelessly or via a cable. This makes it possible for a production manager or the like of the production line 30 to recognize the occurrence of the taking out of the work in process.

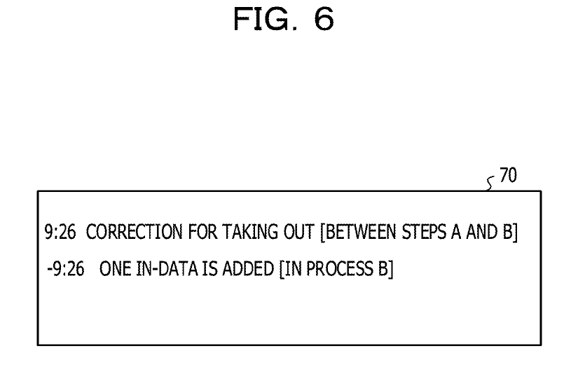

FIG. 6 illustrates an example of the alert screen 70. The alert screen 70 may include, for example, a message indicating the content of the correction data added, in response to the occurrence of the no-work-in-process event, to the work-in-process inventory table 20. In the example illustrated in FIG. 6, the message displayed in the alert screen 70 indicates that correction data is added to make a correction associated with the occurrence of the taking out of the work in process and also indicates time of occurrence thereof.

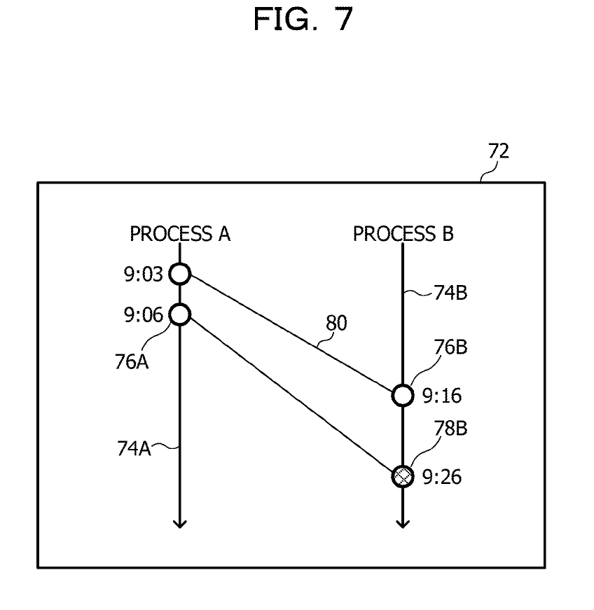

The display control unit 15 displays a work-in-process inventory screen such that data stored in the work-in-process inventory table 20 is displayed in a visualized manner. FIG. 7 illustrates an example of the work-in-process inventory screen 72. In the example illustrated in FIG. 7, the work-in-process inventory table 20 in FIG. 5D is displayed in a visualized manner.

More specifically, as illustrated in FIG. 7, the display control unit 15 displays, on the work-in-process inventory screen 72, an axis 74A corresponding to the process A and associated with time information and an axis 74B extending in parallel to the axis 74A and corresponding to the process B and associated with time information. The display control unit 15 displays points 76A corresponding to respective pieces of data of end logs of the previous process stored in the work-in-process inventory table 20 such that the points 76A are located at positions, on the axis 74A of the process A, corresponding to “time” indicated by the respective pieces of data. The display control unit 15 displays, on the axis 74B of the process B, points 76B corresponding to respective pieces of data of start logs of the following process stored in the work-in-process inventory table 20 and points 78B corresponding to respective pieces of correction data such that the points 76B and the points 78B are located at positions corresponding to “time” indicated by the respective pieces of data. In accordance with the order of the positions where the points are displayed on the axis 74A and axis 74B, the display control unit 15 displays line segments 80 connecting the points 76A on the axis 74A of the process A and the point 76B or the 78B on the axis 74B of the process B.

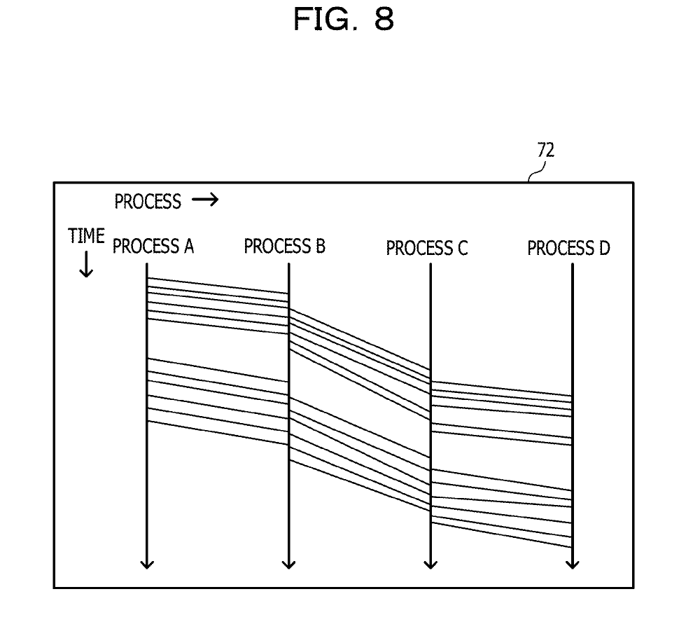

In the example illustrated in FIG. 7, only data between the processes A and B is displayed on the work-in-process inventory screen 72 in a simplified manner. Alternatively, the display control unit 15 may display the work-in-process inventory screen 72 such that information on the full production line 30 is displayed according to work-in-process inventory tables 20 between respective two processes, as illustrated in FIG. 8. The work-in-process inventory screen 72 displayed in this manner makes it possible to intuitively grasp a flow of works in process and a bottle neck in the processes, which may provide helpful information based on which the intermediate buffer size is to be set.

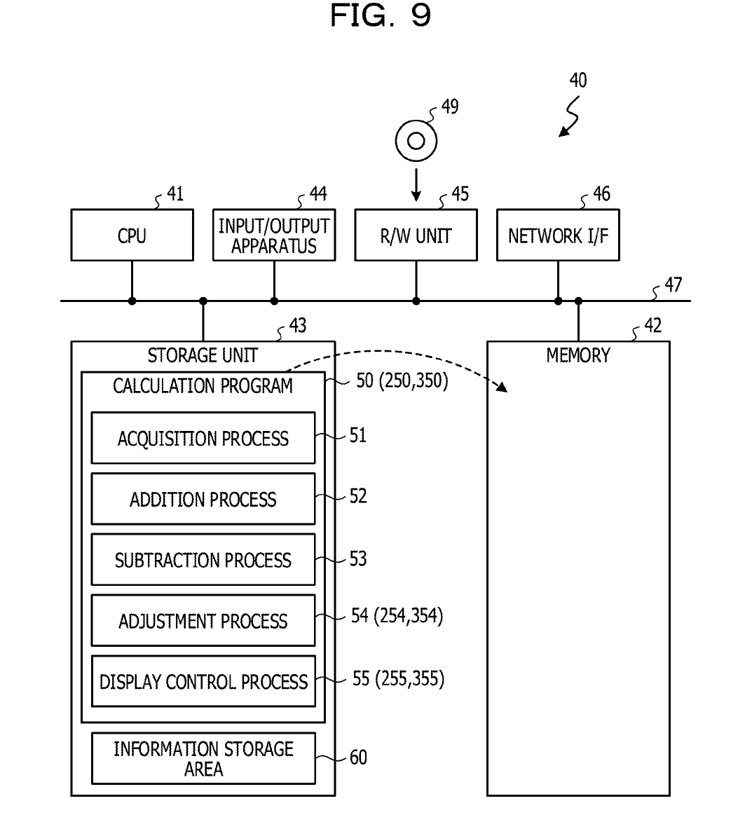

The calculation apparatus 10 may be realized, for example, by a computer 40 illustrated in FIG. 9. The computer 40 includes a central processing unit (CPU) 41, a memory 42 serving as a temporary storage area, and a nonvolatile storage unit 43. The computer 40 also includes an input/output apparatus 44 including an input apparatus, a display apparatus, etc., and a Read/Write (R/W) unit 45 configured to control reading/writing of data to/from a storage medium 49. The computer 40 also includes a communication interface (I/F) 46 connected to a network such as the Internet. The CPU 41, the memory 42, the storage unit 43, the input/output apparatus 44, the R/W unit 45, and the communication I/F 46 are connected to each other via a bus 47.

The storage unit 43 may be realized by a hard disk drive (HDD), a solid state drive (SSD), a flash memory, or the like. In the storage unit 43 serving as a storage medium, a calculation program 50 for allowing the computer 40 to function as the calculation apparatus 10 is stored. The calculation program 50 includes an acquisition process 51, an addition process 52, a subtraction process 53, an adjustment process 54, and a display control process 55. The storage unit 43 includes an information storage area 60 in which information associated with the work-in-process inventory table 20 is stored.

The CPU 41 reads out the calculation program 50 from the storage unit 43, loads it in the memory 42, and sequentially executes the processes included in the calculation program 50. By executing the acquisition process 51, the CPU 41 operates as the acquisition unit 11 illustrates in FIG. 2. By executing the addition process 52, the CPU 41 operates as the addition unit 12 illustrated in FIG. 2. By executing the subtraction process 53, the CPU 41 operates as the subtraction unit 13 illustrated in FIG. 2. By executing the adjustment process 54, the CPU 41 operates as the adjustment unit 14 illustrated in FIG. 2. By executing the display control process 55, the CPU 41 operates as the display control unit 15 illustrated in FIG. 2. The CPU 41 reads out information from the information storage area 60 and loads the work-in-process inventory table 20 in the memory 42 such that when the computer 40 executes the calculation program 50, the computer 40 functions as the calculation apparatus 10. Note that the CPU 41 that executes the programs is hardware.

The functions realized by the calculation program 50 may also be realized, for example, by a semiconductor integrated circuit, and more specifically, by an application specific integrated circuit (ASIC) or the like.

Next, an operation of the calculation apparatus 10 according to the first embodiment is described below.

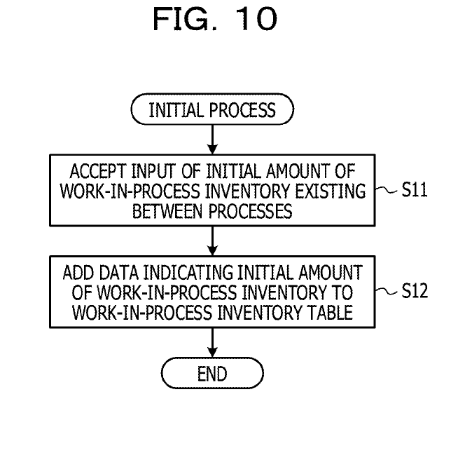

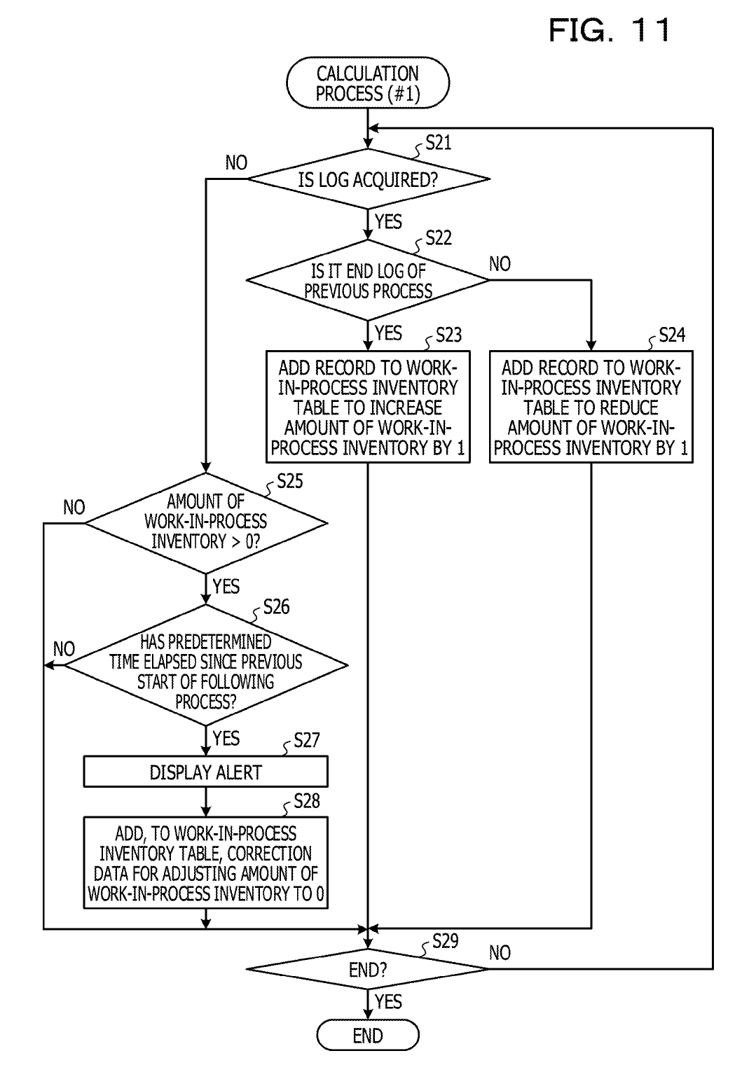

The calculation apparatus 10 executes an initial process illustrated in FIG. 10 at a predetermined time, for example, before the operation of the production line 30 is started. When the operation of the production line 30 is started, the calculation apparatus 10 executes the calculation process (#1) illustrated in FIG. 11. When the calculation apparatus 10 receives an instruction to display the work-in-process inventory screen 72, the calculation apparatus 10 executes a display apparatus illustrated in FIG. 12. The initial process, the calculation process (#1), and the display apparatus are described in detail below.

First, the initial process is described below with reference to FIG. 10.

In S11, the acquisition unit 11 accepts an input in terms of the initial amount of work-in-process inventory indicating the number of works in process existing between processes, and the acquisition unit 11 transfers the initial amount of work-in-process inventory to the addition unit 12.

Next, in S12, the addition unit 12 adds, to the work-in-process inventory table 20, data indicating the initial amount of work-in-process inventory informed from the acquisition unit 11. Thereafter, the initial process is ended.

Next, the calculation process (#1) is described below with reference to FIG. 11.

In S21, the acquisition unit 11 acquires a log from the log apparatus 34 of each device 32, and determines whether the acquired log includes an end log of the previous process or a start log of the following process. In a case where either one of the logs is included, the processing flow proceeds to S22. In a case where neither one of the logs is included, the processing flow proceeds to S25.

In S22, the acquisition unit 11 determines whether the acquired log is an end log of the previous process. In a case where the log acquired in S21 is an end log of the previous process, the processing flow proceeds to S23 in which the acquisition unit 11 transfers the end log of the previous process to the addition unit 12. The addition unit 12 generates data that includes information indicating an end time of the previous process described in the end log received from the acquisition unit 11 and that is to cause 1 to be added to the amount of work-in-process inventory, and the addition unit 12 adds the generated data to the work-in-process inventory table 20. Thereafter, the processing flow proceeds to S29.

On the other hand, in a case where it is determined in S21 that the acquired log is a start log of the following process, the processing flow proceeds to S24, and the acquisition unit 11 transfers the start log of the following process to the subtraction unit 13. The subtraction unit 13 generates data that includes information indicating a start time of the following process described in the start log received from the acquisition unit 11 and that is to cause 1 to be subtracted from the amount of work-in-process inventory, and the subtraction unit 13 adds the generated data to the work-in-process inventory table 20. The adjustment unit 14 resets the measurement of the elapsed time and restarts the measurement of the elapsed time. Thereafter, the processing flow proceeds to S29.

In a case where it is determined in S21 that no log is acquired and thus the processing flow proceeds to S25, the adjustment unit 14 checks the work-in-process inventory table 20 and determines whether the amount of work-in-process inventory indicated in the “inventory” field is greater than 0. In a case where the amount of work-in-process inventory>0, the processing flow proceeds to S26. In a case where the amount of work-in-process inventory≤0, the processing flow proceeds to S29.

In S26, the adjustment unit 14 checks the measured elapsed time and determines whether the time elapsed since the previous storing of data in the work-in-process inventory table 20 in response to a start log of the following process is greater than a predetermined period. In a case where the elapsed time is greater than the predetermined period (for example, 10 minutes), the processing flow proceeds to S27. In a case where the elapsed time is not greater than the predetermined period, the processing flow proceeds to S29.

In S27, the adjustment unit 14 generates a no-work-in-process event indicating that there is no work in process between the processes A and B. In response to the occurrence of the no-work-in-process event, the display control unit 15 displays an alert screen, for example, as illustrated in FIG. 6.

Next, in step S28, in response to the occurrence of the no-work-in-process event, the adjustment unit 14 generates correction data for adjusting the amount of work-in-process inventory indicated in the “inventory” field in the work-in-process inventory table 20 from the current value to 0, and the adjustment unit 14 adds the generated correction data to the work-in-process inventory table 20. Thereafter, the processing flow proceeds to S29.

In S29, it is determined whether the acquisition unit 11 receives a stop signal indicating that the production line 30 stops. In a case where no stop signal is received, the processing flow returns to S21. In a case where the stop signal is received, the calculation process (#1) is ended.

Next, the display apparatus is described below with reference to FIG. 12. As a result of executing the display apparatus, the work-in-process inventory screen 72 is displayed on the display apparatus.

In S31, the display control unit 15 displays an axis 74A corresponding to the process A and associated with time information and an axis 74B extending in parallel to the axis 74A and corresponding to the process B and associated with time information.

Next, in S32, the display control unit 15 displays points 76A corresponding to respective pieces of data of end logs of the previous process stored in the work-in-process inventory table 20 such that the points 76A are located at positions, on the axis 74A of the process A, corresponding to “time” indicated by the respective pieces of data.

Next, in step S33, the display control unit 15 displays points 76B corresponding to respective pieces of data of start logs of the following process stored in the work-in-process inventory table 20 such that the points 76B are located on the axis 74B at positions corresponding to “time” indicated by the respective pieces of data.

Next, in step S34, the display control unit 15 displays points 78B corresponding to respective pieces of correction data stored in the work-in-process inventory table 20 such that the points 74B are located on the axis 74B at positions corresponding to “time” indicated by the respective pieces of data.

Next, in step S35, in accordance with the order of the positions where the points are displayed on the respective axes, the display control unit 15 displays line segments 80 extending between the points 76A on the axis 74A of the process A and the point 76B or the 78B on the axis 74B of the process B. Thereafter, the display apparatus is ended.

As described above, in the first embodiment, the calculation apparatus 10 increases the amount of work-in-process inventory described in the work-in-process inventory table according to an end log of the previous process, and reduces the amount of work-in-process inventory according to a start log of the following process. When the amount of work-in-process inventory described in the work-in-process inventory table is greater than or equal to 1, if time has elapsed without acquiring a start log of the following process over a time period greater than or equal to a predetermined value, the calculation apparatus 10 adjusts the amount of work-in-process inventory to 0. Thus, according to the first embodiment, the calculation apparatus 10 is capable of properly calculating the amount of work-in-process inventory even in a case where taking out of a work in process occurs between processes, which is not detected by an end log of the previous process and a start log of the following process.

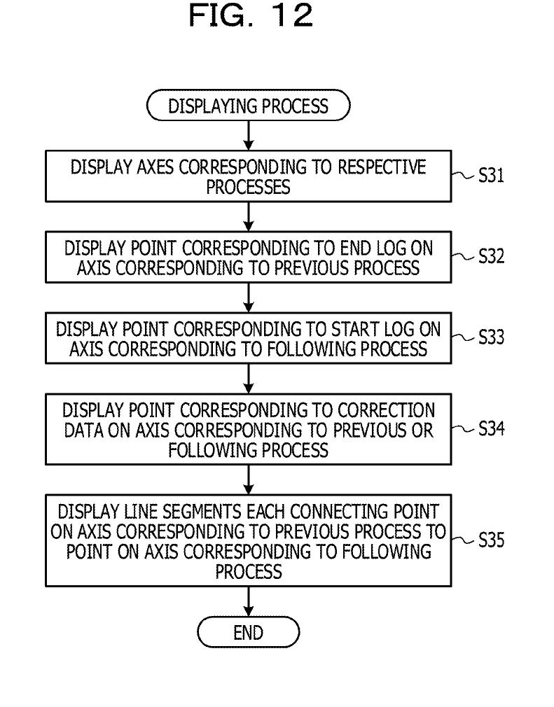

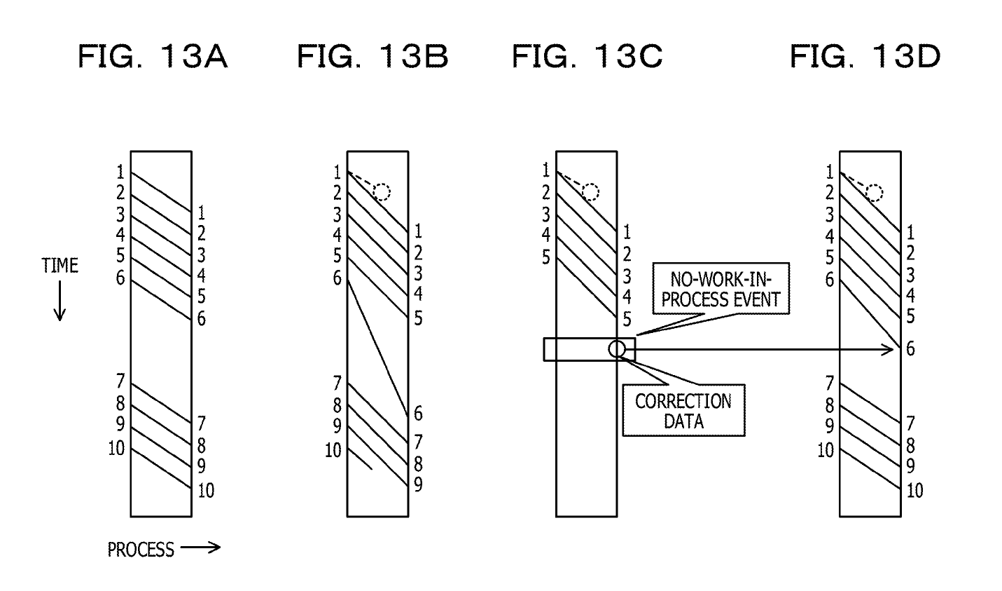

Referring to FIGS. 13A to 13D, effects of the first embodiment are described below from the point of view of associating individual products across processes. In each block illustrated in FIGS. 13A to 13D, as in the work-in-process inventory screen 72 according to the present embodiment described above, the end time of the previous process is represented along a left-hand axis and the start time of the following process is represented along a right-hand axis. Numerals displayed along each axis are serial numbers assigned in the temporal order to the respective points corresponding to data stored in the work-in-process inventory table.

In a case where no taking out occurs, each of the points on the axis of the previous process is correctly associated with the corresponding one of the points on the axis of the following process as illustrated in FIG. 13A. However, in a case where taking out occurs, misassociation occurs after the taking out occurs (as denoted by a dotted circle in FIG. 13B) as illustrated in FIG. 13B. To handle this situation, correction data is added in response to a no-work-in-process event as illustrated in FIG. 13C. In this case, as illustrated in FIG. 13D, although misassociation may occur in a time period in which there is a possibility that taking out has occurred, misassociation is suppressed after the correction data is added.

### Second Embodiment

Next, a second embodiment is described. In a following description of a calculation apparatus according to the second embodiment, elements similar to those of the calculation apparatus 10 according to the first embodiment are denoted by similar reference numerals, and a further detailed description is omitted.

As illustrated in FIG. 1, in the second embodiment, a calculation apparatus 210 is connected to each log apparatus 34 wirelessly or via a cable.

The calculation apparatus 210 includes, as illustrated in FIG. 2, functional blocks including an acquisition unit 11, an addition unit 12, a subtraction unit 13, an adjustment unit 214, and a display control unit 215. A work-in-process inventory table 20 is stored in a predetermined storage area of the calculation apparatus 210.

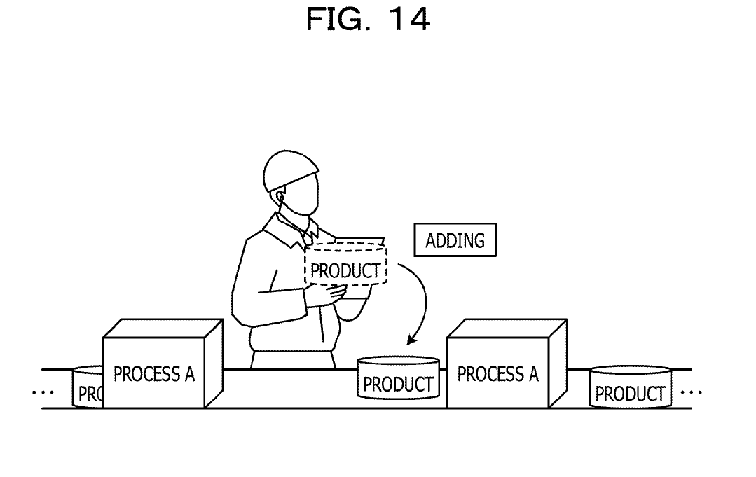

In a production line 30, there is a possibility that a product 36 (a work in process) is added between processes, for example, as illustrated in FIG. 14, by returning a taken-out work in process to the production line or moving a work in process from another line to the production line of interest. However, adding of a work in process between processes is not recorded by a log apparatus 34 of any device 32. Therefore, when adding occurs, the amount of work-in-process inventory between processes determined only from an end log of the previous process and a start log of the following process does not indicate a correct value as illustrated in FIGS. 3A to 3D.

To handle the above situation, the present embodiment provides the adjustment unit 214 that operates such that when the value in the “inventory” field in the work-in-process inventory table 20 becomes negative, the adjustment unit 214 adjusts the amount of work-in-process inventory in the work-in-process inventory table 20 to 0.

More specifically, when the value in the “inventory” field in the work-in-process inventory table 20 becomes negative, the adjustment unit 214 generates a negative inventory event. In response to the occurrence of the negative inventory event, the adjustment unit 214 generates correction data for adjusting the amount of work-in-process inventory described in the “inventory” field from the current value to 0, and the adjustment unit 214 adds the generated correction data to the work-in-process inventory table 20. The adjustment unit 214 sets the value in the “time” field in the correction data to the same value as that indicated in the “time” field of the above-described data in which the “inventory” field becomes negative.

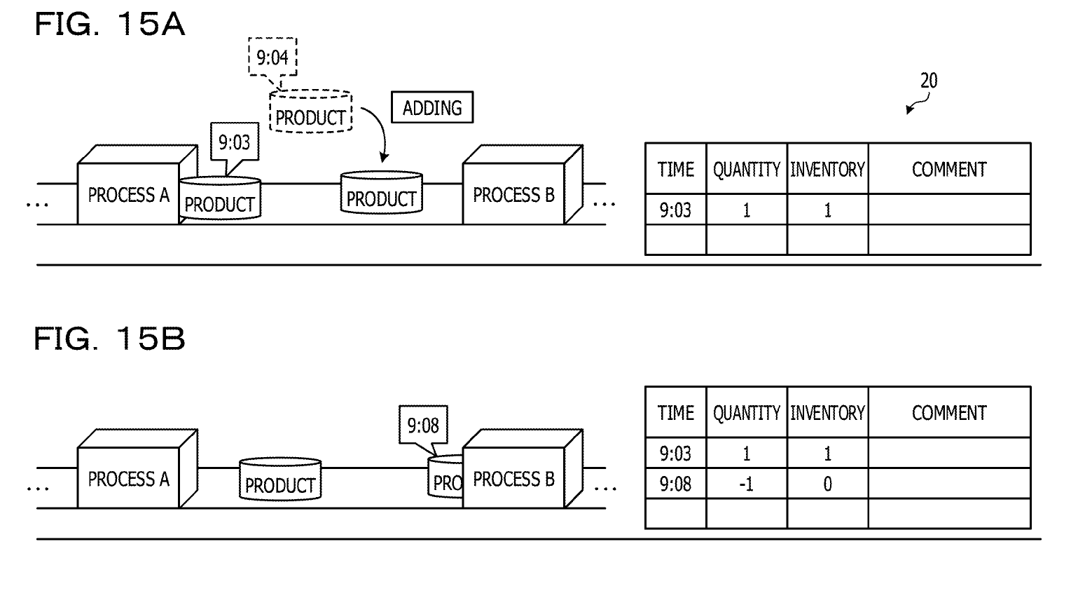

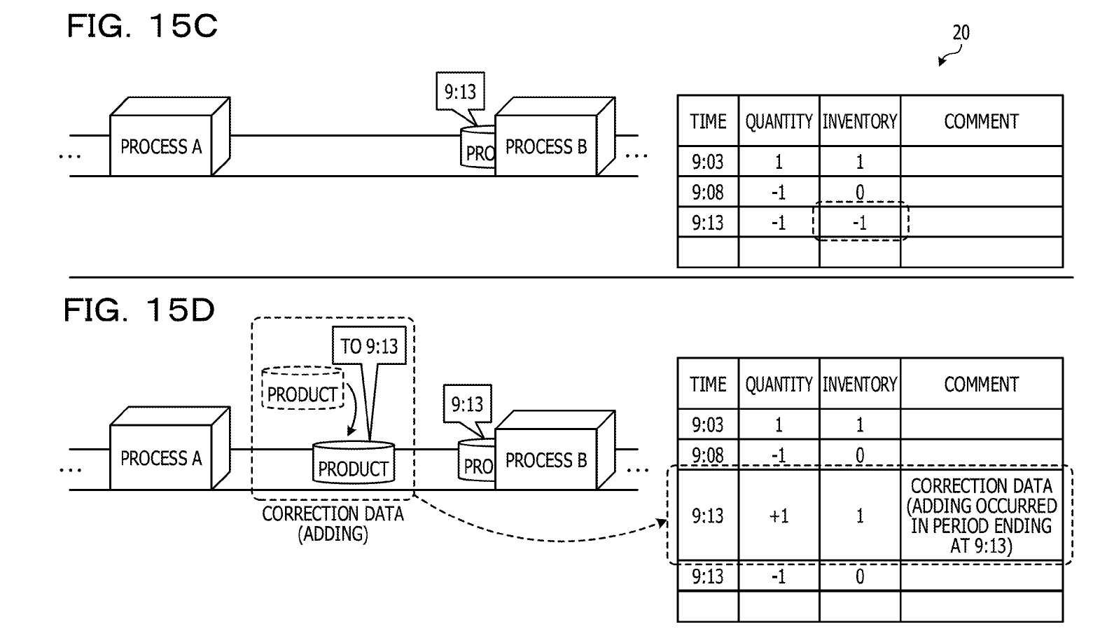

Referring to FIGS. 15A to 15D, an example of a process performed by the adjustment unit 214 is described below. As illustrated in FIG. 15A, in response to an end log of the previous process at 9:03, the addition unit 12 adds data for adding 1 to the amount of work-in-process inventory in a similar manner to FIG. 3A. As a result, the value in the “inventory” field in the work-in-process inventory table 20 becomes equal to “1”. In this state, let it be assumed by way of example that a work in process is added at 9:04 between the processes A and B, at a position ahead of another work in process whose previous process is completed at 9:03, as illustrated in FIG. 15A. However, this situation is not detected by the log apparatus 34, and thus no change occurs in the “inventory” field in the work-in-process inventory table 20 although the actual amount of work-in-process inventory has increased by 1.

Let it be assumed by way of example that the following process for the added work in process is started at 9:08 as illustrated in FIG. 15B. In response to this start log, the subtraction unit 13 adds data for subtracting 1 from the amount of work-in-process inventory. As a result, the value in the “inventory” field becomes equal to “0”. Furthermore, the following process for a following work in process is started at 9:13 and the subtraction unit 13 adds data for subtracting 1 from the amount of work-in-process inventory. As a result, the value in the “inventory” field becomes equal to “4”. In response to the change in the value in the “inventory” field to a negative value, the adjustment unit 214 generates a negative inventory event. The adjustment unit 214 generates correction data in which “9:13” is described in the “time” field and “+1” is described in the “quantity” field to cause the value in the “inventory” field in the work-in-process inventory table 20 to be changed from the current value of −1 to “+1”, and the adjustment unit 214 adds the generated correction data to the work-in-process inventory table 20.

The adjustment unit 214 describes, in the “comment” field of the correction data, information indicating that the data of interest is correction data and information indicating a time period in which there is a possibility that adding of a work in process has occurred. The time period in which there is a possibility that addition of a work in process has occurred is a period until the value in the “inventory” field in the work-in-process inventory table 20 becomes negative. This description makes it possible to grasp the time period in which the work in process is likely to have been added. The correction data added by the adjustment unit 214 is data indicating adding of a work in process as represented in an area surrounded by a dotted line in FIG. 15D.

In response to the occurrence of the negative inventory event in the adjustment unit 214, the display control unit 215 displays an alert screen on a display apparatus disposed in the calculation apparatus 210 or a display apparatus connected to the calculation apparatus 210 wirelessly or via a cable. This makes it possible for a production manager or the like of the production line 30 to recognize the occurrence of adding of the work in process.

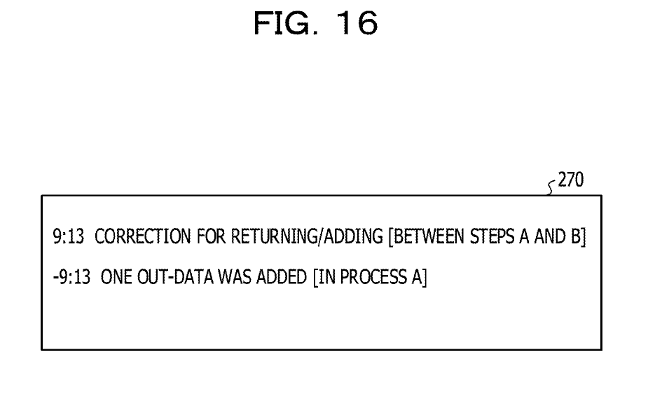

FIG. 16 illustrates an example of the alert screen 270. The alert screen 270 may include, for example, a message indicating the content of the correction data added to the work-in-process inventory table 20 in response to the occurrence of the negative inventory event. In the example illustrated in FIG. 16, the alert screen 270 includes a message indicating that correction data is added to make a correction associated with the occurrence of the taking out of the work in process, and also indicates time of occurrence thereof.

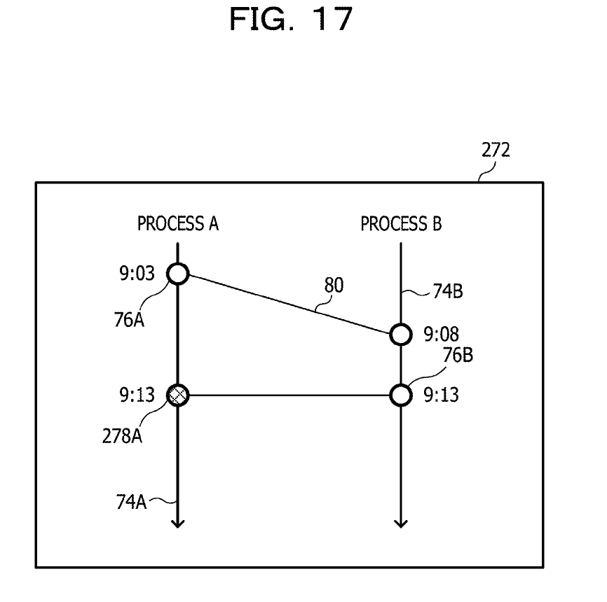

The display control unit 215 displays a work-in-process inventory screen such that data stored in the work-in-process inventory table 20 is displayed in a visualized manner. FIG. 17 illustrates an example of the work-in-process inventory screen 272 in a simplified manner. In the example illustrated in FIG. 17, the work-in-process inventory table 20 in FIG. 15D is displayed in a visualized manner. The work-in-process inventory screen 272 is similar to the work-in-process inventory screen 72 according to the first embodiment except that a point 278A corresponding to correction data is disposed on an axis 74A corresponding to the process A.

The calculation apparatus 210 may be realized, for example, by a computer 40 illustrated in FIG. 9. In the storage unit 43 of the computer 40, a calculation program 250 for allowing the computer 40 to function as the calculation apparatus 210 is stored. The calculation program 250 includes an acquisition process 51, an addition process 52, a subtraction process 53, an adjustment process 254, and a display control process 255.

The CPU 41 reads out the calculation program 250 from the storage unit 43, loads it in the memory 42, and sequentially executes the processes included in the calculation program 250. By executing the adjustment process 254, the CPU 41 operates as the adjustment unit 214 illustrated in FIG. 2. By executing the display control process 255, the CPU 41 operates as the display control unit 215 illustrated in FIG. 2. The other processes are similar to corresponding processes of the calculation program 50 according to the first embodiment. Thus it becomes possible for the computer 40 to function as the calculation apparatus 210 by executing the calculation program 250.

The functions realized by the calculation program 250 may also be realized, for example, by a semiconductor integrated circuit, and more specifically by an ASIC or the like.

Next, an operation of the calculation apparatus 210 according to the second embodiment is described below. In the second embodiment, a calculation process is different from that according to the first embodiment. Referring to FIG. 18, a calculation process (#2) according to the second embodiment is described below. In a following description of the calculation process (#2) according to the second embodiment, similar steps to those in the calculation process (#1) according to the first embodiment are denoted by similar reference step numbers, and a further description thereof is omitted.

After S24 in the calculation process (#2) illustrated in FIG. 18, the processing flow proceeds to S41. In S41, the adjustment unit 214 checks the work-in-process inventory table 20 and determines whether the amount of work-in-process inventory indicated in the “inventory” field is negative. In a case where amount of work-in-process inventory<0, the processing flow proceeds to S42. In a case where amount of work-in-process inventory≥0, the processing flow proceeds to S29.

In S42, the adjustment unit 214 generates a negative inventory event. In response to the occurrence of the negative inventory event, the adjustment unit 214 generates correction data for adjusting the amount of work-in-process inventory indicated in the “inventory” field from the current value to 0. The adjustment unit 214 adds the generated correction data to the work-in-process inventory table 20 such that it is located before the data indicating the negative amount of work-in-process inventory.

Next, in step S43, in response to the addition of the correction data, the adjustment unit 214 adjusts the value in the “inventory” field of the data of interest.

In S44, in response to the occurrence of the negative inventory event in the adjustment unit 214, the display control unit 215 displays an alert screen 270, for example, as illustrated in FIG. 16. Thereafter, the processing flow proceeds to S29.

As described above, in the second embodiment, the calculation apparatus 210 increases the amount of work-in-process inventory described in the work-in-process inventory table according to an end log of the previous process, and reduces the amount of work-in-process inventory according to a start log of the following process. When the amount of work-in-process inventory described in the work-in-process inventory table becomes negative, the calculation apparatus 210 adjusts the amount of work-in-process inventory to 0. Therefore, even in a case where adding of a work in process occurs between processes, which is not detected by an end log of the previous process and a start log of the following process, it is possible to properly calculate the amount of work-in-process inventory as in the first embodiment.

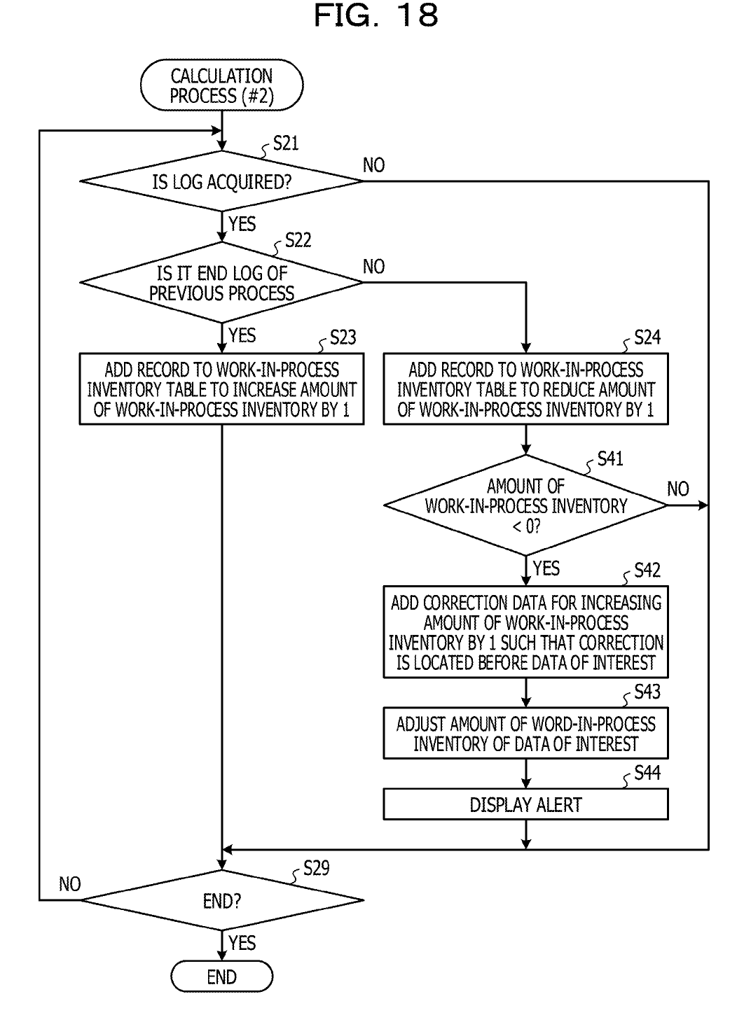

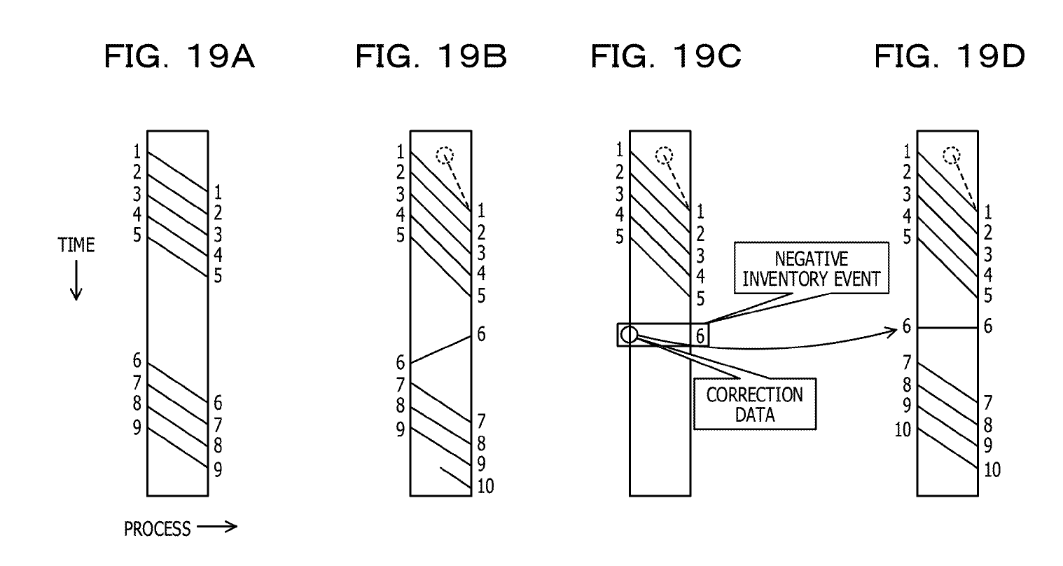

Referring to FIGS. 19A to 19D, effects of the second embodiment are described below from the point of view of associating individual products across processes. In a case where no addition occurs, each of the points on the axis of the previous process is correctly associated with the corresponding one of the points on the axis of the following process as illustrated in FIG. 19A. However, in a case where adding occurs, misassociation occurs after the addition occurs (as denoted by a dotted circle in FIG. 19B) as illustrated in FIG. 19B. To handle this situation, as illustrated in FIG. 19C, correction data is added in response to a negative inventory event. In this case, as illustrated in FIG. 19D, although misassociation may occur in a time period in which there is a possibility that adding occurs, misassociation is suppressed after the correction data is added.

### Third Embodiment

Next, a third embodiment is described. In a following description of a calculation apparatus according to the third embodiment, elements similar to those of the calculation apparatus 10 according to the first embodiment are denoted by similar reference numerals, and a further detailed description is omitted.

As illustrated in FIG. 1, according to the third embodiment, a calculation apparatus 310 is connected to each log apparatus 34 wirelessly or via a cable.

The calculation apparatus 310 includes, as illustrated in FIG. 2, functional blocks including an acquisition unit 11, an addition unit 12, a subtraction unit 13, an adjustment unit 314, and a display control unit 315. A work-in-process inventory table 20 is stored in a predetermined storage area of the calculation apparatus 310.

In some cases, an intermediate buffer size indicating a maximum allowable number of works in process between processes is determined depending on a physical restriction between the processes. In a case where the amount of work-in-process inventory described in the work-in-process inventory table 20 is greater than the intermediate buffer size, there is a possibility that taking out of a work in process has occurred. As described above in the first embodiment, taking out of the work in process between the processes is not recorded by a log apparatus 34 of any device 32. Therefore, when taking out occurs, the amount of work-in-process inventory between processes determined only from an end log of the previous process and a start log of the following process does not indicate a correct value, as illustrated in FIGS. 3A to 3D.

To handle the above situation, in the present embodiment, in a case where the value in the “inventory” field in the work-in-process inventory table 20 is greater than the intermediate buffer size, the adjustment unit 314 adjusts the amount of work-in-process inventory in the work-in-process inventory table 20 to the value corresponding to the intermediate buffer size.

More specifically, in the case where the amount of work-in-process inventory indicated in the “inventory” field in the work-in-process inventory table 20 is greater than the intermediate buffer size, the adjustment unit 314 generates a buffer overflow event. In response to the occurrence of the buffer overflow event, the adjustment unit 314 generates correction data for adjusting the amount of work-in-process inventory indicated in the “inventory” field from the current value to the value corresponding to the intermediate buffer size, and the adjustment unit 314 adds the generated correction data to the work-in-process inventory table 20. In the generation of the correction data, the adjustment unit 314 sets the value in the “time” field of the correction data to be equal to the value described in the “time” field of the data in which the value in the “inventory” field is greater than the intermediate buffer size.

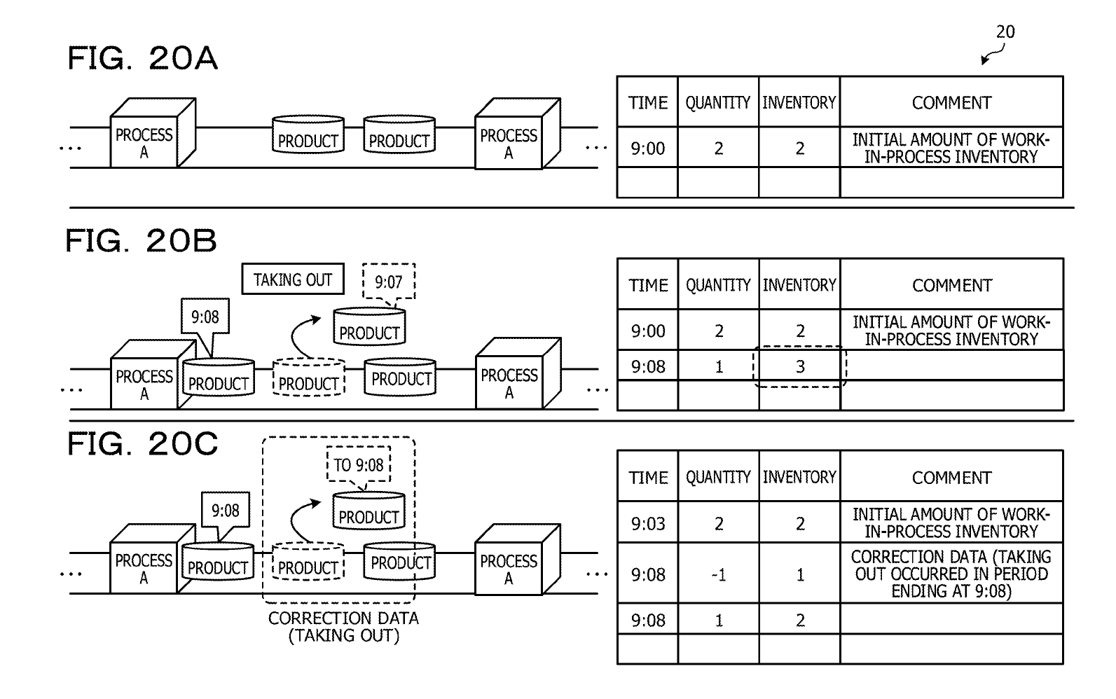

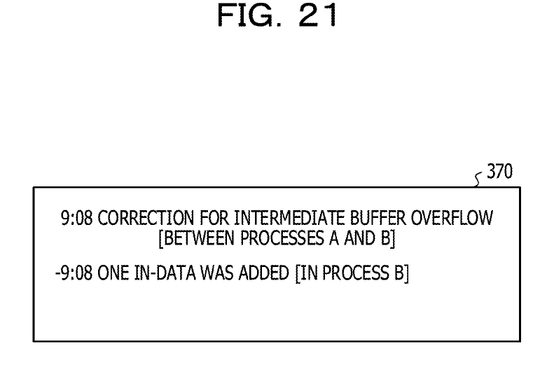

Referring to FIGS. 20A to 20C, an example of a process performed by the adjustment unit 314 is described below. Here, let it be assumed by way of example that the intermediate buffer size is 2 and the initial amount of work-in-process inventory is 2 as illustrated in FIG. 20A. In this situation, let it be assumed by way of example that taking out of a work in process occurs at 9:07 as illustrated in FIG. 20B. However, the taking out of the work in process is not detected by the log apparatus 34, and thus no change occurs in the “inventory” field in the work-in-process inventory table 20 although the actual amount of work-in-process inventory has decreased by 1.

Let it be assumed by way of example that the previous process for a next work in process ends at 9:08 as illustrated in FIG. 20C. In response to this end log, the addition unit 12 adds, to the work-in-process inventory table 20, data for adding 1 to the initial amount of work-in-process inventory, and thus the value in the “inventory” field becomes equal to 3, which is greater than the intermediate buffer size of 2. In response to the increase in the value in the “inventory” field beyond the intermediate buffer size, the adjustment unit 314 generates a buffer overflow event. The adjustment unit 314 generates correction data in which “9:08” is described in the “time” field and “−1” is described in the “quantity” field to cause the value in the “inventory” field in the work-in-process inventory table 20 from the current value of 3 to the intermediate buffer size of 2 as illustrated in FIG. 20C. The adjustment unit 314 adds the generated correction data to the work-in-process inventory table 20.

The adjustment unit 314 describes, in the “comment” field of the correction data, information indicating that the data of interest is correction data and information indicating a time period in which there is a possibility that taking out of a work in process has occurred. The time period in which there is a possibility that taking out of a work in process has occurred is a period until the value in the “inventory” field in the work-in-process inventory table 20 becomes greater than the intermediate buffer size. This makes it possible to grasp the time period in which the taking out of the work in process has occurred. The correction data added by the adjustment unit 314 is data describing the taking out of the work in process that occurs as represented in an area surround by a dotted line in FIG. 20C.

In response to the occurrence of the buffer overflow event in the adjustment unit 314, the display control unit 315 displays an alert screen on a display apparatus disposed in the calculation apparatus 310 or a display apparatus connected to the calculation apparatus 310 wirelessly or via a cable. This makes it possible for a production manager or the like of the production line 30 to recognize the occurrence of the taking out of the work in process.

FIG. 21 illustrates an example of the alert screen 370. The alert screen 370 may include, for example, a message indicating the content of the correction data added, in response to the occurrence of the buffer overflow event, to the work-in-process inventory table 20. In the example illustrated in FIG. 21, the message displayed in the alert screen 370 indicates that correction data is added to make a correction associated with the occurrence of the buffer overflow and also indicates time of occurrence thereof.

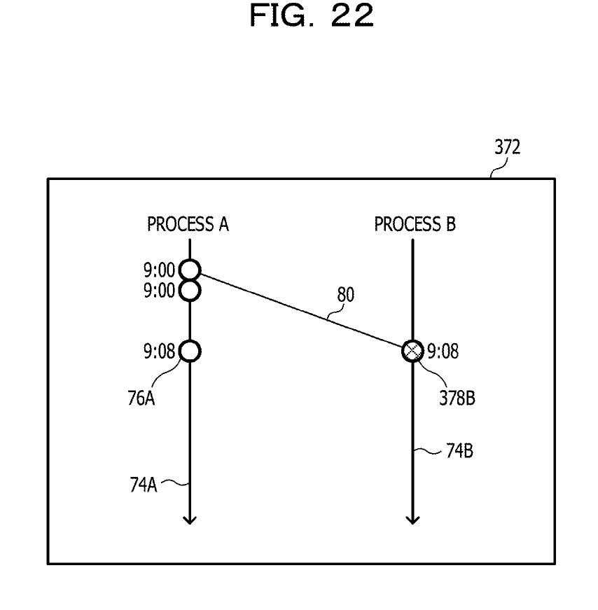

The display control unit 315 displays a work-in-process inventory screen such that data stored in the work-in-process inventory table 20 is displayed in a visualized manner. FIG. 22 illustrates an example of the work-in-process inventory screen 372 in a simplified manner. In the example illustrated in FIG. 22, the work-in-process inventory table 20 in FIG. 20C is displayed in a visualized manner. In the work-in-process inventory screen 372, a point 378B corresponding to correction data is displayed on an axis 74B corresponding to the process B. A point corresponding to data indicating an initial work-in-process inventory is displayed on an axis corresponding to the end of the previous process (in the present example, an axis 74A corresponding to the process A).

The calculation apparatus 310 may be realized, for example, by a computer 40 illustrated in FIG. 9. In the storage unit 43 of the computer 40, a calculation program 350 for allowing the computer 40 to function as the calculation apparatus 310 is stored. The calculation program 350 includes an acquisition process 51, an addition process 52, a subtraction process 53, an adjustment process 354, and a display control process 355.

The CPU 41 reads out the calculation program 350 from the storage unit 43 and loads it in the memory 42. The CPU 41 then sequentially executes the processes included in the calculation program 350. By executing the adjustment process 354, the CPU 41 operates as the adjustment unit 314 illustrated in FIG. 2. By executing the display control process 355, the CPU 41 operates as the display control unit 315 illustrated in FIG. 2. The other processes are similar to corresponding processes of the calculation program 50 according to the first embodiment. Thus it becomes possible for the computer 40 to function as the calculation apparatus 310 by executing the calculation program 350.

The functions realized by the calculation program 350 may also be realized, for example, by a semiconductor integrated circuit, and more specifically by an ASIC or the like.

Next, an operation of the calculation apparatus 310 according to the third embodiment is described below. In the third embodiment, a calculation process is different from that according to the first embodiment. Referring to FIG. 23, a calculation process (#3) according to the third embodiment is described below. In a following description of the calculation process (#3) according to the third embodiment, elements similar to those of the calculation process (#1) according to the first embodiment are denoted by similar reference numerals, and a further detailed description is omitted.

After S23 in the calculation process (#3) illustrated in FIG. 23, the processing flow proceeds to S51. In S51, the adjustment unit 314 checks the work-in-process inventory table 20 and determines whether the amount of work-in-process inventory indicated in the “inventory” field is greater than the intermediate buffer size. In a case where amount of work-in-process inventory>intermediate buffer size, the processing flow proceeds to S52. In a case where amount of work-in-process inventory intermediate buffer size, the processing flow proceeds to S29.

In S52, the adjustment unit 314 generates a buffer overflow event. In response to the occurrence of the buffer overflow event, the adjustment unit 314 generates correction data for adjusting the amount of work-in-process inventory indicated in the “inventory” field to from the current value to the value equal to the intermediate buffer size. The adjustment unit 314 adds the generated correction data to the work-in-process inventory table 20 such that it is located before the data indicating that the amount of work-in-process inventory is larger than the intermediate buffer size.

Next, in step S53, in response to the addition of the correction data, the adjustment unit 314 adjusts the value in the “inventory” field of the data of interest.

In response to the occurrence of the buffer overflow event in the adjustment unit 314, the display control unit 315 displays an alert screen 370, for example, as illustrated in FIG. 21. Thereafter, the processing flow proceeds to S29.

As described above, according to the third embodiment, the calculation apparatus 310 increases the amount of work-in-process inventory described in the work-in-process inventory table according to an end log of the previous process, and reduces the amount of work-in-process inventory according to a start log of the following process. In a case where the amount of work-in-process inventory described in the work-in-process inventory table is greater than the set intermediate buffer size, the adjustment unit 310 adjusts the amount of work-in-process inventory to the value corresponding to the intermediate buffer size. Therefore, even in a case where taking out of a work in process occurs between processes, which is not detected by an end log of the previous process and a start log of the following process, it is possible to properly calculate the amount of work-in-process inventory as in the first embodiment.

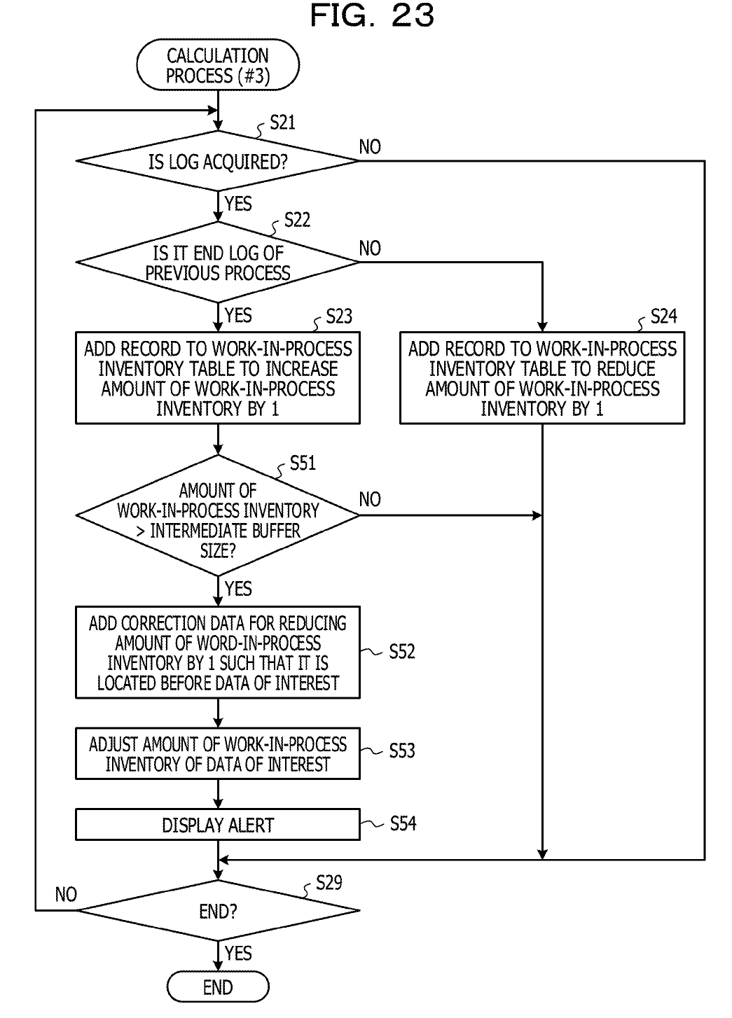

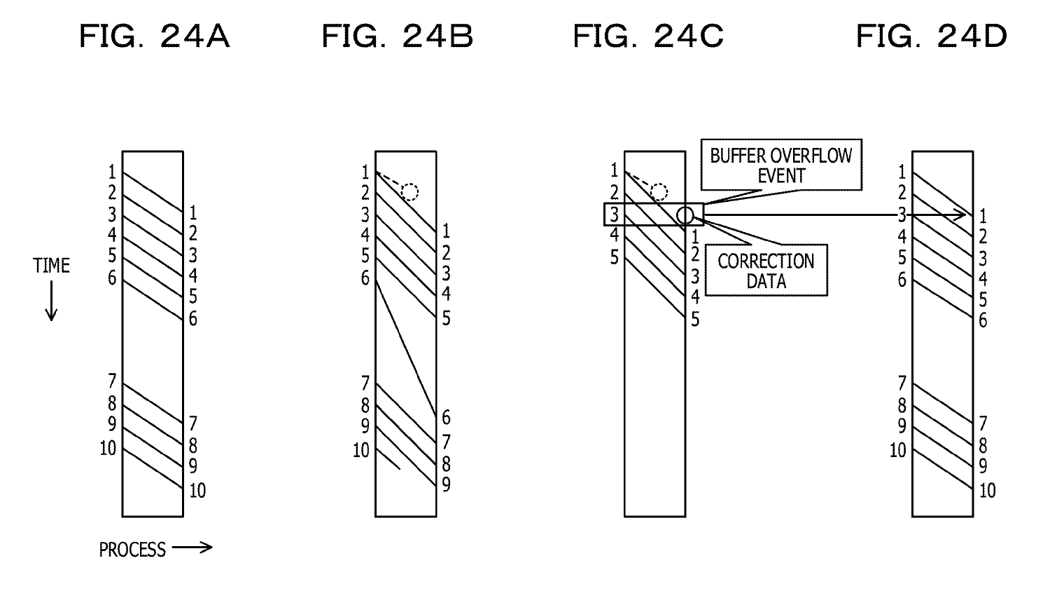

Referring to FIGS. 24A to 24D, effects of the third embodiment are described below from the point of view of associating individual products across processes. In a case where no taking out occurs, each of the points on the axis of the previous process is correctly associated with the corresponding one of the points on the axis of the following process as illustrated in FIG. 24A. However, in a case where taking out occurs, misassociation occurs after the taking out occurs (as denoted by a dotted circle in FIG. 24B) as illustrated in FIG. 24B. To handle this situation, as illustrated in FIG. 24C, correction data is added according to the buffer overflow event when the buffer overflow occurs. In this case, as illustrated in FIG. 24D, although misassociation may occur in a time period until the occurrence of the buffer overflow, misassociation is suppressed after the correction data is added. In this third embodiment, compared with the first embodiment in which correction data is added in response to a no-work-in-process event, it is possible to quickly detect an occurrence of taking out of a work in process and add correction data with no significant delay.

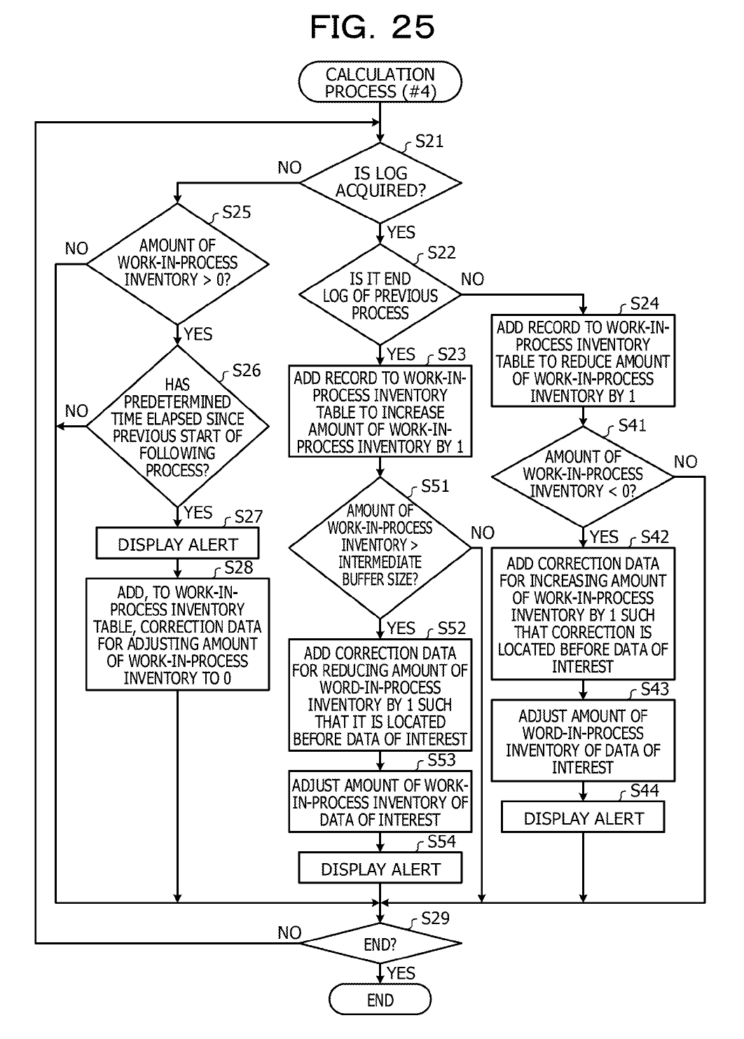

The first embodiment has been described above for the case in which correction data is added in response to a no-work-in-process event. The second embodiment has been described above for the case in which correction data is added in response to a negative inventory event. The third embodiment has been described above for the case in which correction data is added in response to a buffer overflow event. Alternatively, correction data may be added to all of these events. In this case, a calculation process (#4) may be performed as illustrated in FIG. 25. In the calculation process (#4) illustrated in FIG. 25, steps S41 to S44 in the calculation process (#2) according to the second embodiment are added to the calculation process (#1) according to the first embodiment such that steps S41 to S44 are performed after step S24 in the calculation process (#1). Furthermore, steps S51 to S54 in the calculation process (#3) according to the third embodiment are added after step S23 of the calculation process (#1) according to the first embodiment.

In each embodiment described above, it is assumed by way of example that in response to an occurrence of an event, an alert screen is displayed on the display apparatus. However, alternatively, an alert may be provided by a voice/sound. Note that the display control units 15, 215, ad 315 according to the respective embodiments are examples of the output unit according to the technique of the present disclosure.

In the embodiments described above, it is assumed by way of example but not limitation that the calculation programs 50, 250, and 350 are stored (installed) in advance in the storage unit 43. Alternatively, part or all of the programs according to the present disclosure may be stored in a storage medium such as a CD-ROM, a DVD-ROM, a USB memory, or the like, and the programs may be provided via the storage medium.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An information processing method executed by a processor included in an information processing apparatus configured to calculate a number of in-process products existing between a first process executed by a first device and a second process executed following the first process by a second device in a production line, the information processing method comprising:
acquiring, from the first device, an end log indicating an event of ending of the first process;
adding a value to the number of in-process products according to the acquired end log;
acquiring, from the second device, a start log indicating an event of starting of the second process;
subtracting a value from the number of in-process products according to the acquired start log; and
adjusting the number of in-process products to 0 when it is determined that no start log of the second process has occurred over a period longer than or equal to a threshold value in a state where the number of in-process products is greater than or equal to 1.

2. The information processing method according to claim 1, further comprising
outputting information indicating that taking out of an in-process product has occurred in the production line is output, when it is determined that no start log of the second process has occurred over a period longer than or equal to a threshold value in a state where the number of in-process products is greater than or equal to 1.

3. The information processing method according to claim 1, further comprising
storing, in a memory, the number of in-process products depending on the adjustment in association with time corresponding to a period in which no start log of the second process has occurred, the memory configured to store the number of in-process products in association with time of occurrence of the start log or the end log causing a change in the number of in-process products.

4. The information processing method according to claim 1, further comprising:
displaying a first axis and a second axis in parallel to the first axis, the first and second axes each associated with time; and
displaying one or more line segments each connecting a point on the first axis and a point on the second axis according to an arrangement order along each axis wherein the point on the first axis corresponds to the end log of the first process, and the point on the second axis is a point corresponding to the start log of the second process or a point corresponding to the adjusting.

5. The information processing method according to claim 1, wherein the adjusting includes
adding correction data to the number of in-process products, the correction data causing the number of in-process products to become equal to 0.

6. An information processing method executed by a processor included in an information processing apparatus configured to calculate a number of in-process products existing between a first process executed by a first device and a second process executed following the first process by a second device in a production line, the information processing method comprising:
acquiring, from the first device, an end log indicating an event of ending of the first process;
adding a value to the number of in-process products according to the acquired end log;
acquiring, from the second device, a start log indicating an event of starting of the second process;
subtracting a value from the number of in-process products according to the acquired start log;
adjusting the number of in-process products to 0 when it is determined that the number of in-process products has become negative.

7. The information processing method according to claim 6, further comprising
outputting information indicating that adding of an in-process product occurs in the production line is output when it is determined that the number of in-process products has become negative.

8. The information processing method according to claim 6, further comprising
adding correction data to data stored in a memory, the correction data indicating that the number of in-process products is greater than or equal to 1 in association with time that is the same as or earlier than the time associated with the number of in-process products stored, in response to the adjusting, in the memory, the memory configured to store the number of in-process products in association with time of occurrence of a start log or an end log causing a change in the number of in-process products.

9. The information processing method according to claim 8, further comprising:
displaying a first axis and a second axis in parallel to the first axis, the first and second axes each associated with time; and
displaying one or more line segments each connecting a point on the first axis and a point on the second axis according to an arrangement order along each axis wherein the point on the first axis is a point corresponding to the end log of the first process or a point corresponding to the adjusting, and the point on the second axis corresponds to the start log of the second process.

10. An information processing apparatus configured to calculate a number of in-process products existing between a first process executed by a first device and a second process executed following the first process by a second device in a production line, the information processing apparatus comprising:
a memory; and
a processor coupled to the memory and configured to:
acquire, from the first device, an end log indicating an event of ending of the first process,
add a value to the number of in-process products according to the acquired end log,
acquire, from the second device, a start log indicating an event of starting of the second process,
subtract a value from the number of in-process products according to the acquired start log, and
adjust the number of in-process products to 0 when it is determined that no start log of the second process has occurred over a period longer than or equal to a threshold value in a state where the number of in-process products is greater than or equal to 1.

11. The information processing apparatus according to claim 10, wherein the processor is configured to
output information indicating that taking out of an in-process product has occurred in the production line is output, when it is determined that no start log of the second process has occurred over a period longer than or equal to a threshold value in a state where the number of in-process products is greater than or equal to 1.

12. The information processing apparatus according to claim 10, wherein the processor is configured to:
store, in a memory, the number of in-process products depending on the adjustment in association with time corresponding to a period in which no start log of the second process has occurred, the memory configured to store the number of in-process products in association with time of occurrence of the start log or the end log causing a change in the number of in-process products.

13. The information processing apparatus according to claim 10, wherein the processor is configured to:
display a first axis and a second axis in parallel to the first axis, the first and second axes each associated with time, and
display one or more line segments each connecting a point on the first axis and a point on the second axis according to an arrangement order along each axis wherein the point on the first axis corresponds to the end log of the first process, and the point on the second axis is a point corresponding to the start log of the second process or a point corresponding to the adjusting.

14. The information processing apparatus according to claim 10, wherein the processor is configured to
add correction data to the number of in-process products, the correction data causing the number of in-process products to become equal to 0.
